(19) United States
(12) Patent Application Publication
(10) Pub. No.: US 2012/0174985 A1
(43) Pub. Date: Jul. 12, 2012

(54) LAMINATE SPOOL VALVE

(76) Inventors: James A. O'Brien, II, LaSalle, MI (US); Matthew W. Witte, Tecumseh, MI (US); Benjamin Piotter, Deerfield, MI (US)

(21) Appl. No.: 13/346,797

(22) Filed: Jan. 10, 2012

Related U.S. Application Data
(60) Provisional application No. 61/431,229, filed on Jan. 10, 2011.

(51) Int. Cl. F16K 11/00

(52) U.S. Cl. 137/1; 137/625.3

(57) ABSTRACT

A method and apparatus for controlling the logic of a spool valve including providing a valve block having a bore and a plurality of ports formed therein, the ports in fluid communication with the bore. A spool is selectively movable in the valve block and in fluid communication with the ports. A plurality of annular laminates is located on the spool, wherein each of the annular laminates comprises an outer diameter and an inner diameter. The outer diameter of each of the annular laminates seals against the bore and the inner diameter seals against the spool. A laminate plug is secured within the bore and compresses the annular laminates within the bore. Guiding the annular laminates by the spool controls the logic of the spool valve.

### CROSS-REFERENCE TO RELATED APPLICATION

This application claims the benefit of U.S. provisional patent application Ser. No. 61/431,229 filed Jan. 10, 2011.

### FIELD OF THE INVENTION

This invention relates to spool valves for hydraulic fluid flow control and more particularly to an apparatus and a method for forming a high precision spool valve.

### BACKGROUND OF THE INVENTION

Spool valves embody a common hydraulic flow direction control technology that has remained unchanged for many years. FIG. 1 illustrates a hydraulic system 10 with a typical prior art spool valve 12 used to drive a pressurized hydraulic piston 14 and an axially slidable piston rod 16. The spool valve 12 includes a spool 18 movable within a valve block 20. The valve block 20 includes flow passages 22 and a cylindrical sealing surface 24. The spool 18 includes lands 26 with O-rings 28 for sealing the lands 26 against the sealing surface 24 of the valve block 20. Movement of the spool 18 aligns the lands 26 with selected ones of the flow passages 22 while sealingly engaging the surface 24 of the valve block 20. When the spool valve 12 is set in the “push” position “A” (handle shown in solid line), fluid flows from a pump 30 into the bottom of the valve block 20a between the lands 26 and out to the left end of a cylinder 34. Fluid in the right end of the cylinder 34 flows into the bottom of the valve block 20a while the fluid in the top of the valve block 20b is allowed to flow out into a hydraulic tank 32. This pushes the piston 14 to the right, sliding the piston rod 16 in the direction “A”. When the spool valve 12 is set in the “pull” position “B” (handle shown in dashed line to move the spool 18 to the right), fluid flows into the right end of the cylinder 34 and out of the left end of the cylinder 34 through the valve 12, causing the piston 14 to pull back into cylinder 34, sliding the piston rod 16 in the direction “B”.

Recent advances in hydraulic technology have made higher system operating pressures common. Higher pressures demand precise control, which in turn, is driving a need for better spool valves. Current high pressure spool valve designs rely on a precision ground spool with a close tolerance fit to a single bore. Because of the economics of machining the bore, it is often made of a material much softer than the spool. This hardness mismatch leads to uneven wear of the surfaces and excessive leak rates in high pressure circuits. It is desirable therefore, to provide an economical spool valve with robust bore and spool that would have a longer service life and offer more economical service with reduced leak rates.

### SUMMARY OF THE INVENTION

The present invention relates to a spool valve that is made of hardened materials between the spool and the bore and is economical to produce.

In one embodiment, a spool valve comprises a valve block having a bore and a plurality of ports formed therein, the ports in fluid communication with the bore; a spool selectively movable in the valve block and in fluid communication with the ports; and a plurality of annular laminates located on the spool, wherein each of the annular laminates comprises an inner diameter sealing against the spool.

In another embodiment, a spool valve comprises a spool; and a plurality of annular laminates located on the spool, wherein each of the annular laminates comprises an inner diameter sealing against the spool.

A method for controlling the logic of a spool valve comprising the steps of providing a valve block having a bore and a plurality of ports formed therein, the ports in fluid communication with the bore; providing a spool selectively movable in the valve block and in fluid communication with the ports; providing a plurality of annular laminates located on the spool, wherein each of the annular laminates comprises an outer diameter and an inner diameter; sealing the outer diameter of each of the annular laminates against the bore; sealing the inner diameter of each of the annular laminates against the spool; securing a laminate plug within the bore; compressing the annular laminates within the bore with the laminate plug; and guiding the annular laminates by the spool.

### DESCRIPTION OF THE DRAWINGS

The above as well as other advantages of the present invention will become readily apparent to those skilled in the art from the following detailed description of a preferred embodiment when considered in the light of the accompanying drawings in which:

FIG. 1 is a schematic view of a prior art spool valve and operating system;

FIG. 2 is a perspective view of a high precision spool valve according to the present invention;

FIG. 3 is an exploded perspective view of the spool and laminate cartridge parts of the spool valve illustrated in FIG. 2; and

FIG. 4 is an enlarged view of a set of laminate cartridges.

### DESCRIPTION OF THE PREFERRED EMBODIMENT

The U.S. provisional patent application Ser. No. 61/431,229 filed Jan. 10, 2011 is incorporated herein by reference.

The following detailed description and appended drawings describe and illustrate various exemplary embodiments of the invention. The description and drawings serve to enable one skilled in the art to make and use the invention, and are not intended to limit the scope of the invention in any manner. In respect of the methods disclosed, the steps presented are exemplary in nature, and thus, the order of the steps is not necessary or critical.

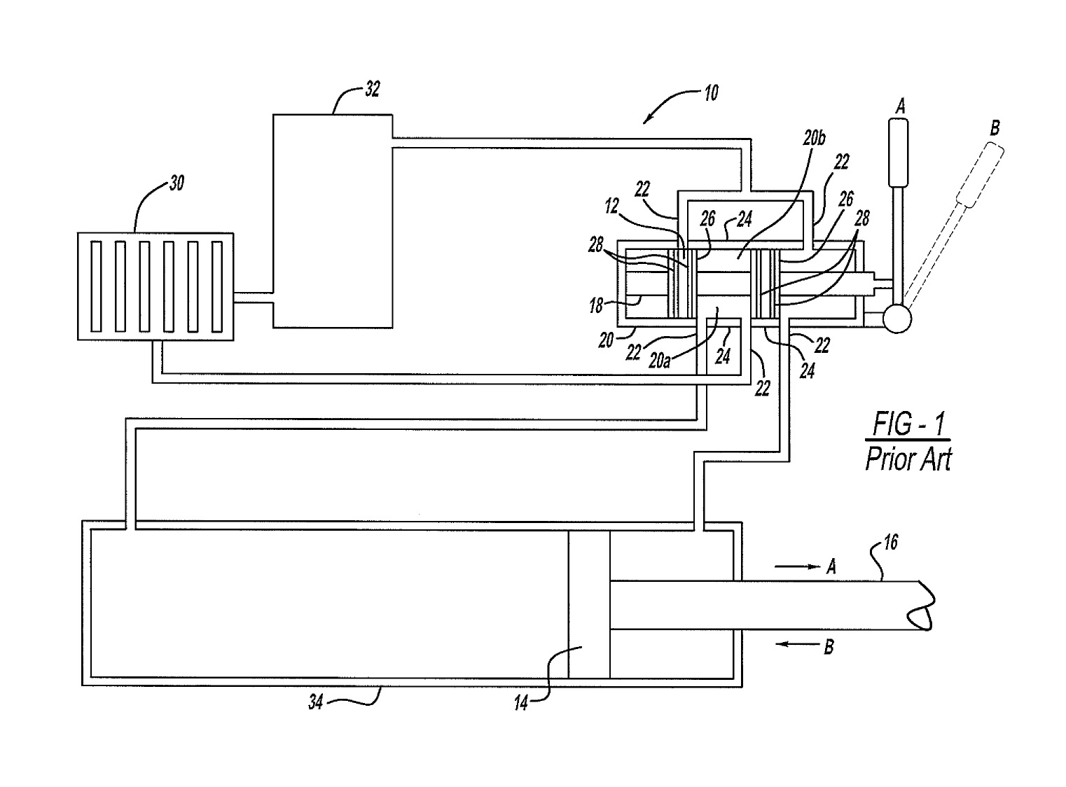

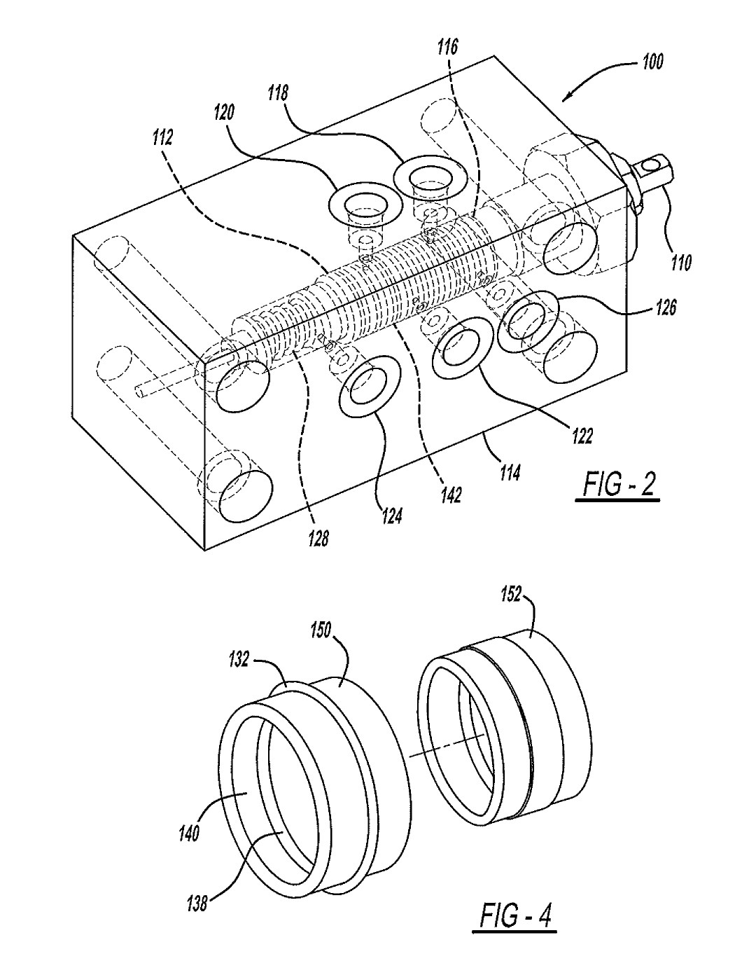

FIG. 1 illustrates a hydraulic system 10 with a typical prior art spool valve 12 used to drive a pressurized hydraulic piston 14 and axially slidable piston rod 16. With reference to FIG. 2, a high precision spool valve 100 according to the present invention is there shown. The high precision spool valve 100 includes a spool 110 selectively movable in a precision bore 112 of a valve block 114. The valve block 114 has formed therein an inner diameter (ID) bore 116 having two standard directional pressure outlets 118 and 120; a pressure feed port 122; and two fluid return ports 124 and 126 for returning a fluid to a tank (not shown). The direction of the fluid flow between standard pressure outlets 118 and 120 is determined by the position of the spool 110. The spool 110 includes a spring 128. The spool 110 is spring loaded to automatically return to a neutral position when released. The operation of the high precision spool valve 100 is identical in scope to the operation of the spool valve 10 described above and illustrated in FIG. 1.

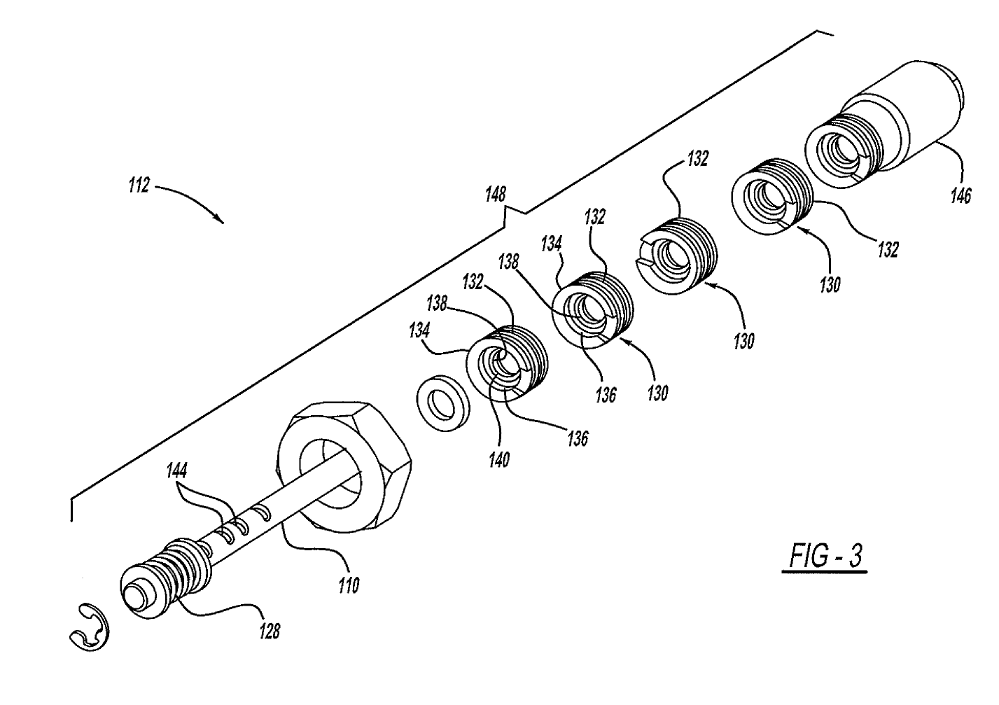

FIG. 3 illustrates an embodiment of the assembly of the precision bore 112 and the spool 110 within the high precision spool valve 100 of the present invention. The precision bore 112 is a stack of precision-machined annular laminates 130 that locate on the spool 110, Each precision annular laminate 130 includes an O-ring 132 about an outer diameter (OD) 134 of the precision annular laminate 130 for sealing the OD 134 to the ID bore 116 of the valve block 114. Additionally, the precision annular laminate 130 includes an inner diameter (ID) 136 for receiving the spool 110. The ID 136 of the precision annular laminate 130 includes flow passages 138 and lands 140. A chamber 142 is formed between each of the precision annular laminates 130 and the precision bore 112 when the precision annular laminate 130 are stacked within the precision bore 112 (FIG. 2). The spool 110 includes depressions; such as dimples 144 for aligning with the flow passages 138 in each ID 136 of the precision annular laminate 130 or sealing against the lands 140 on the ID 136 of each precision annular laminate 130. The OD 134 of the precision bore 112 is required to only seal the O-rings 132 within the ID bore 116 of the valve block 114, eliminating the need for a precision ground surface as required by the prior art valve of FIG. 1. Instead, the precision surface is on the ID 136 of the precision annular laminates 130 and this precision surface serves to both seal the precision annular laminate 130 to the spool 110 and to locate the precision annular laminates 130 relative to the spool 110. The high precision fit between the spool 110 and each precision annular laminate 130 creates the seal. The O-ring 132 seals the OD 134 of each precision annular laminate 130, keeping the chambers 142 between the precision annular laminates 130 segregated. A laminate plug 146 screws into the valve block 114 and compresses the precision annular laminates 130 together creating tension with the spring 128 and forming overall a laminated cartridge 148. The net effect of the embodiment is the same as a single long bore as illustrated in FIG. 1, but the seals and control logic are located by the spool 110 and the precision annular laminates 130 instead of the spool 18 and the valve block 20 of the prior art. Additionally, the precision annular laminates 130 are composed of equal hardness materials in a form that is easy to precision machine.

FIG. 4 illustrates another embodiment of the precision annular laminates 130 of the present invention. A first set of precision annular laminates 150 is there shown for seating within the ID bore 116 of the valve block 112. A second set of precision annular laminates 152 is seated within the first set of precision annular laminates 150. Each set of precision annular laminates 150, 152 may include any configuration of fluid passages and lands for controlling the hydraulic fluid flow. Multiple sets of precision annular laminates may be seated within a correlating set of precision annular laminates for controlling the hydraulic fluid flow within the high precision spool valve 100 of the present invention. The laminated cartridge 148 can be configured to create any needed valve logic. Additionally, multiple laminate cartridges 148 may be interfaced with at least one of one or more spools 110 and one or more precision bores 112.

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A spool valve comprising:
a valve block having a bore and a plurality of ports formed therein, the ports in fluid communication with the bore;
a spool selectively movable in the valve block and in fluid communication with the ports; and
a plurality of annular laminates located on the spool, wherein each of the annular laminates comprises an inner diameter sealing against the spool.

2. The spool valve of claim 1, wherein each of the annular laminates further comprises an outer diameter sealing against the bore.

3. The spool valve of claim 1, further comprising a laminate plug threaded into the valve block within the bore and compressing the annular laminates together.

4. The spool valve of claim 3, wherein the plurality of laminates and the laminate plug combine to form a laminate cartridge disposed within the bore of the valve block, the laminate cartridge configured to create the spool valve logic.

5. The spool valve of claim 1, wherein the spool further comprises a dimple, the dimple locating at least one of the plurality of annular laminates on the spool.

6. The spool valve of claim 5, wherein the inner diameter of the at least one of the plurality of annular laminates comprises at least one flow passage and at least one land, and at least one of the annular laminates is selectively movable about the dimple of the spool.

7. The spool valve of claim 1, wherein said plurality of annular laminates is a first set of annular laminates, and further comprising a second set of annular laminates seated within the first set of annular laminates.

8. A spool valve comprising:
a spool; and
a plurality of annular laminates located on the spool, wherein each of the annular laminates comprises an inner diameter sealing against the spool.

9. The spool valve of claim 8, wherein the spool further comprises a plurality of dimples, the dimples locating at least one of the plurality of annular laminates on the spool.

10. The spool valve of claim 8, wherein each of the inner diameters of the plurality of annular laminates comprises at least one flow passage and at least one land, and each of the annular laminates is selectively movable about the dimples of the spool.

11. The spool valve of claim 8, wherein said plurality of annular laminates is a first set of annular laminates, and further comprising a second set of annular laminates seated within the first set of annular laminates.

12. The spool valve of claim 8, further comprising:
a valve block having a bore and a plurality of ports formed therein, the ports in fluid communication with the bore;
a spool selectively movable in the valve block and in fluid communication with the ports; and
wherein each of the annular laminates further comprises an outer diameter sealing against the bore.

13. The spool valve of claim 12, further comprising a laminate plug threaded into the valve block within the bore and compressing the annular laminates together.

14. The spool valve of claim 13, wherein the plurality of laminates and the laminate plug combine to form a laminate cartridge disposed within the bore of the valve block, the laminate cartridge configured to create the spool valve logic.

15. The spool valve of claim 14, wherein the spool guides the laminate cartridge.

16. The spool valve of claim 14, wherein said laminate cartridge is interfaced with a plurality of laminate cartridges and configured to create the spool valve logic.

17. The spool valve of claim 14, wherein said laminate cartridge is interfaced with a plurality of spools and configured to create the spool valve logic.

18. The spool valve of claim 14, further comprising multiple laminate cartridges interfaced with at least one of one or more spools and one or more precision bores.

19. A method for controlling the logic of a spool valve comprising the steps of:
providing a valve block having a bore and a plurality of ports formed therein, the ports in fluid communication with the bore;
providing a spool selectively movable in the valve block and in fluid communication with the ports;
providing a plurality of annular laminates located on the spool, wherein each of the annular laminates comprises an outer diameter and an inner diameter;
sealing the outer diameter of each of the annular laminates against the bore;
sealing the inner diameter of each of the annular laminates against the spool;
securing a laminate plug within the bore;
compressing the annular laminates within the bore with the laminate plug; and
guiding the annular laminates by the spool.

20. The method of claim 19, further comprising the steps of:
providing the spool with a plurality of dimples; and
the dimples locating the annular laminates on the spool.
